(19) United States
(12) Patent Application Publication
(10) Pub. No.: US 2023/0082209 A1
(43) Pub. Date: Mar. 16, 2023

(54) LIGHT AND REDOX CURABLE COMPOSITIONS

(71) Applicant: 3M INNOVATIVE PROPERTIES COMPANY, St. Paul, MN (US)

(72) Inventors: Katherine A. Gibney, St. Paul, MN (US); Ying Lin, Superior, CO (US)

(21) Appl. No.: 17/789,466

(22) PCT Filed: Dec. 21, 2020
(86) PCT No.: PCT/IB2020/062296

§ 371 Date: Jun. 27, 2022

Related U.S. Application Data
(60) Provisional application No. 62/954,945, filed on Dec. 30, 2019.

(51) Int. Cl. C08F 220/12; B32B 15/04; B32B 15/18; B32B 7/12

(52) U.S. Cl. CPC C08F 220/12; B32B 15/04; B32B 15/18; B32B 7/12; B32B 2255/06; B32B 2255/26; B32B 2605/08

(57) ABSTRACT

Two-part curable compositions comprising a Part A component comprising a polymerizable monomer having one (meth)acryl group, an adhesion promoter, a urethane (meth)acrylate crosslinker having at least two (meth)acryl groups, a non-urethane (meth)amylate crosslinker having at least two (meth)acryl groups, a catalyst system, and a photoinitiator system, and a Part B component comprising barbituric acid or a derivative thereof, and optionally an organic peroxide curative. Methods of making curable compositions, methods of sealing a substrate and methods of adhering two substrates are provided.

### TECHNICAL FIELD

The present disclosure broadly relates to curable compositions and methods of making and using the same.

### BACKGROUND

Curable compositions are widely used in the chemical arts for applications such as, for example, sealants and adhesives. In general, the curable composition is at least partially cured to provide a usable end product. In some cases, the curable composition may be a single (one-part) composition that can be triggered (e.g., by light and/or heat) to cause curing. In other cases, it is preferable to separate the composition into two parts (two-part) that, when mixed, begin to cure. Such systems are known in the art as two-part curable compositions. The two separate parts of two-part compositions are commonly referred to in the art as Part A and Part B. Examples of curable compositions include curable sealants and adhesives.

### SUMMARY

The present disclosure describes a dual-cure sealant system, where the primary cure mechanism is triggered by an actinic radiation source and the secondary cure mechanism is a redox reaction. Using such a dual-cure sealant system, an end user can cure the provided sealant systems with a blue-light device under most circumstances, while the secondary cure mechanism ensures that any shadowed areas, areas of abnormal thickness, etc. will still fully cure. The end user is also provided with control over work and cure times.

In one aspect, provided herein are two-part curable compositions comprising a Part A component comprising a polymerizable monomer having one (meth)acryl group, an adhesion promoter, a urethane (meth)acrylate crosslinker having at least two (meth)acryl groups, a non-urethane (meth)acrylate crosslinker having at least two (meth)acryl groups, a catalyst system, and a photoinitiator system, and a Part B component comprising barbituric acid or a derivative thereof, and optionally an organic peroxide curative.

In another aspect, provided is a method of making curable compositions, the method comprising combining the Part A and Part B components of the two-part curable composition of the present disclosure.

Also provided are methods of sealing a substrate and methods of adhering two substrates.

Before any embodiments of the present disclosure are explained in detail, it is to be understood that the phraseology and terminology used herein is for the purpose of description and should not be regarded as limiting.

In this document, the terms “a,” “an,” or “the” are used to include one or more than one unless the context clearly dictates otherwise.

The term “(meth)acrylate” as used herein refers to monomers or oligomers comprising at least one (meth)acryloyloxy group having the formula CH₂═CR—(CO)—O— where R is hydrogen (i.e., acrylate) or methyl (i.e., methacrylate).

The term “alkyl” as used herein refers to straight chain and branched alkyl groups having from 1 to 40 carbon atoms (C₁-C₄₀), 1 to about 20 carbon atoms (C₁-C₂₀), 1 to 12 carbons (C₁-C₁₂), 1 to 8 carbon atoms (C₁-C₈), 1 to 6 carbon atoms (C₁-C₆) or, in some embodiments, from 3 to 6 carbon atoms (C₃-C₆). Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include isopropyl, iso-butyl, sec-butyl, t-butyl, neopentyl, isopentyl, and 2,2-dimethylpropyl groups.

The term “alkoxy” as used herein refers to the group —O-alkyl, wherein “alkyl” is defined herein.

The term “aryl” as used herein refers to cyclic aromatic hydrocarbons that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons (C₆-C₁₄) or from 6 to 10 carbon atoms (C₆-C₁₀) in the ring portions of the groups.

The term “aspect ratio” as used herein refers to average particle lengths (longest dimension) divided by average particle widths. The aspect ratio is determined by measuring the length and width of a plurality of particles on an electron micrograph and dividing the average of the lengths by the average of the widths.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “0.1% to 5%” or “0.1% to 5%” should be interpreted to include not just 0.1% to 5%, but also the individual values (e.g., 1%, 2%, 3%, and 4%) and the sub-ranges (e.g., 0.1% to 0.5%, 1.1% to 2.2%, 3.3% to 4.4%) within the indicated range.

Features and advantages of the present disclosure will be further understood upon consideration of the detailed description as well as the appended claims.

### DETAILED DESCRIPTION

Curable compositions are often used in the automotive industry as sealants and protective coatings, particularly along joints or seams where two or more parts are secured together. Curing that is activated by moisture and/or heat and can have curing times that vary with composition and environmental conditions. Curing that is activated solely by light can be compromised when a sealant is applied at a thickness that does not allow actinic radiation to penetrate to a sufficient depth of the sealant layer and/or when the sealant is in a location partially or completely obscured from the curing light source. Not only does uncured material compromise the performance of a seam sealer, the resulting free acrylates also present a sensitization risk to those who come into contact with them. Moreover, compositions that cure quickly (e.g., within 15 minutes) provide for very little work time, i.e., open time, during which the user can sculpt and configure the composition. On the other hand, compositions that cure relatively slowly offer longer work time but may take several hours to fully cure, thus requiring a waiting period before painting or other follow-up work can be done. The present disclosure describes curable compositions that are both light and redox curable and that give the user greater control over work and cure times, thus minimizing or eliminating the disadvantages cited above. Provided herein are two-part curable compositions comprising a Part A component and a Part B Component.

### Part A Component

The Part A component comprises a polymerizable monomer having one (meth)acryl group, an adhesion promoter, a urethane (meth)acrylate crosslinker having at least two (meth)acryl groups, a non-urethane (meth)acrylate crosslinker having at least two (meth)acryl groups, a catalyst system, and a photoinitiator system.

### Polymerizable Monomers Having One (Meth)Acryl Group

Suitable polymerizable monomers having one (meth)acryl group useful in curable compositions of the present disclosure include one or more monomers that have a single ethylenically unsaturated group that is typically miscible with a urethane multifunctional (meth)acrylate. Such mono (meth)acrylates can reduce crosslinking density so that the cured composition is elastomeric. Examples of mono (meth)acrylates include benzyl methacrylate, isooctyl acrylate (e.g., commercially available as SR-440 from Sartomer, Exton, Pa.), isodecyl acrylate (e.g., commercially available as SR-395 from Sartomer), isobornyl acrylate (e.g., commercially available as SR-506 from Sartomer), 2-phenoxyethyl acrylate (e.g., commercially available as SR-339 from Sartomer), alkoxylated tetrahydrofurfuryl acrylate (e.g., commercially available as CD-611 from Sartomer), 2(2-ethoxyethoxy)ethylacrylate (e.g., commercially available as SR-256 from Sartomer), ethoxylated nonylphenol acrylate (e.g., commercially available as SR-504 from Sartomer), propoxylated tetrahydrofurfuryl acrylate (e.g., commercially available as SR-611 from Sartomer), 2-phenoxyethyl methacrylate (e.g., commercially available as SR-340 from Sartomer), tetrahydrofurfuryl methacrylate (e.g., commercially available as SR-203 from Sartomer), alkoxylated phenol acrylate monomer (e.g., commercially available as SR-9087 from Sartomer), p-cumyl phenoxyethyl acrylate (e.g., commercially available as CD590 from Sartomer), 2-hydroxy-3-phenoxypropyl acrylate (e.g., commercially available as CN3100 from Sartomer), acrylic oligomer (e.g., commercially available as CN 2285 from Sartomer), phenol (EO)2 acrylate (e.g., commercially available as MIRAMER M142 from Miwon), Nonyl phenol (PO)2 acrylate (e.g., commercially available as MIRAMER M1602 from Miwon), o-phenylphenol EO acrylate (e.g., commercially available as MIRAMER M1142 from Miwon). Other polymerizable monomers having one (meth)acryl group include, for example, methyl styrene, styrene, divinyl benzene, and the like.

Other suitable polymerizable monomers having one (meth)acryl group comprise monomers with a single ethylenically unsaturated group having a urethane linkage (—NH—(CO)—O—), such as urethane (meth)acrylates and 2-[[(butylamino)carbonyl]oxy]ethyl acrylate, which is commercially available under the trade designation GENOMER G1122 from Rahn USA Corp. in Aurora, Ill.

Suitable polymerizable monomers having one (meth)acryl group typically do not include monomers having ethylenically unsaturated groups containing an ionic group, such as an acidic group or an amino group, or monomers having ethylenically unsaturated groups containing a hydroxyl group.

In some embodiments, the curable composition can comprise 10-80 wt. %, 15-50 wt. %, or 20-40 wt. % of one or more polymerizable monomers having one (meth)acryl group.

Preferably, the curable compositions comprise low volatile organics (“VOC”). Such compositions are good for the environment and reduce potential odors generated by the curing process. In preferred embodiments, the polymerizable monomer having one (meth)acryl group has a vapor pressure less than 0.1 Pa at 25° C., more particularly less than 0.01 Pa, and even more particularly less than 0.001 Pa. Such diluents are less likely to be volatized during the curing process. In some embodiments, the polymerizable monomer having one (meth)acryl group comprises a mono(meth)acrylate.

### Adhesion Promoters

Suitable adhesion promoters may include acid-functionalized (meth)acrylate monomers such as acrylic acid (AA), methacrylic acid (MAA), beta-carboxyethyl acrylate (β-CEA), 2-hydroxy ethyl methacrylate (HEMA) phosphate, mono-2-(Methacryloyloxy)ethyl succinate (known as HEMA succinate commercially available from Esstech Inc, Essington, Pa.), 2-hydroxyethyl methacrylate (HEMA) maleate (known as HEMA maleate commercially available from Esstech Inc, Essington, Pa.), (meth)acrylic phosphonic acids and esters 6-methacryloxyhexyl phosphate, 10-methacryloxydecyl phosphate, glycerol phosphate mono(meth)acrylates, caprolactone methacrylate phosphate, bis((meth)acryloxyethyl) phosphate, and glycerol phosphate di(meth)acrylates.

Suitable adhesion promoters may also include acid-precursor functionalities, such as anhydride-functionalized (meth)acrylate monomers (e.g., 4-Methacryloxyethyl trimellitic anhydride), and pyrophosphate-functionalized (meth)acylate monomers (e.g. tetramethacryloxyethyl pyrophosphate).

An adhesion promoter may be used alone or in combination with one or more additional adhesion promoters. In some embodiments, the adhesion promoter is mono(meth)acrylate with carboxylic acid or carboxylic anhydride.

In some embodiments, the curable composition may further comprise a secondary adhesion promotor. The secondary adhesion promoter may be selected from (3-acryloxypropyl)trimethoxysilane, methacryloxypropyltrimethoxy silane, (3-acryloxypropyl)methyldimethoxysilane, (methacryloxymethyl)methyldiethoxysilane, methacryloxypropyldimethylethoxysilane, methacryloxypropyldimethylmethoxysilane, and combinations thereof.

In some embodiments, the curable composition comprises 5-40 wt. %, 10-35 wt. %, or 15-30 wt. %, of one or more adhesion promoters.

### Urethane (Meth)Acrylate Crosslinker

Urethane (meth)acrylate crosslinkers useful in embodiments of the present disclosure include at least two (meth)acryl groups. Such urethane (meth)acrylate crosslinkers are typically used to impart flexibility and toughness to the cured composition. Suitable urethane (meth)acrylate crosslinkers for use in the curable compositions include oligomers and prepolymers comprising aliphatic urethane multifunctional (meth)acrylates and aromatic urethane multifunctional (meth)acrylates. In some embodiments, the urethane (meth)acrylate crosslinkers are selected from urethane di(meth)acrylates, urethane tri(meth)acrylates, urethane tetra(meth)acrylates and combinations thereof. In some embodiments, the urethane (meth)acrylate crosslinkers is a di(meth)acrylate.

Suitable urethane (meth)acrylate crosslinkers can be made by reacting polyols with polyisocyanates to form urethane moieties and terminating the urethane moieties with multifunctional (meth)acrylates. In some embodiments, the urethane multifunctional (meth)acrylate is a urethane di(meth)acrylate comprising a carbocyclic aromatic group or a hydrocarbon group with at least four carbon atoms. In other embodiments, the urethane multifunctional (meth)acrylate is a urethane di(meth)acrylate comprising polytetramethylene oxide or polypropylene oxide. In some preferred embodiments, the urethane multifunctional (meth)acrylate comprises a polyester, a polypropylene oxide, or polytetramethylene oxide backbone. Polyethylene oxide backbones were found to be less favorable. In some embodiments, the urethane multifunctional (meth)acrylate is relatively hydrophobic.

Suitable aromatic urethane (meth)acrylate crosslinkers can be derived from the reaction product of a polyol, an aromatic diisocyanate (e.g., toluene diisocyanate), and a hydroxyalkyl (meth)acrylate (e.g., hydroxyethyl (meth)acrylate and hydroxypropyl (meth)acrylate). Particularly desirable polyols include polyether polyols, polyester polyols, polylactone polyols, polysiloxane polyols, poly(alkylacrylate) polyols, and poly(glycidyl ether) polyols.

Suitable aliphatic urethane (meth)acrylate crosslinkers can be derived from the reaction product of polyether polyols (e.g., hydroxyl terminated polypropylene oxide or hydroxyl terminated polytetramethylene oxide), aliphatic diisocyanates (e.g., isophorone diisocyanate), and a hydroxyalkyl (meth)acrylate (e.g., hydroxylethyl (meth)acrylate or hydroxypropyl (meth)acrylate). Suitable aliphatic urethane multifunctional (meth)acrylates also include an aliphatic urethane multifunctional (meth)acrylate having a polycaprolactone backbone. For example, a hydroxylethyl (meth)acrylate ring opens the caprolactone forming a mono-alcohol that is reacted with isophorone diisocyanate, resulting hydrophobic aliphatic urethane di(meth)acrylate.

Commercially available urethane (meth)acrylate crosslinkers include those from Allnex (Germany) under the trademark EBECRYL and designations 244, 264, 265, 1290, 4833, 4883, 8210, 8311, 8402, 8405, 8807, 5129, and 8411; those available from Sartomer under the designations, CN 973H85, CN 985B88, CN 964, CN 944B85, CN 963B80, CN 973J75, CN 973H85, CN 929, CN 996, CN 966J75, CN 968, CN 980, CN 981, CN 982B88, CN 982B90, CN 983, CN991, CN 2920, CN 2921, CN 2922, CN 9001, CN 9005, CN 9006, CN 9007, CN 9009, CN 9010, CN 9031, CN 9782; GENOMER 4212, 4215, 4217, 4230, 4256, 4267, 4269, 4302, and 4316 and UA 00-022 available from Rahn; PHOTOMER 6892 and 6008 available from Cognis; and NK OLIGO U24A and U-15HA available from Kowa. Additional urethane multifunctional (meth)acrylates include the BR series of aliphatic urethane (meth)acrylates such as BR 144 or 970 available from Bomar Specialties or the LAROMER series of aliphatic urethane (meth)acrylates such as LAROMER LR 8987 from BASF.

Commercially available urethane (meth)acrylate crosslinkers for use in the curable compositions include those known by the trade designations: PHOTOMER (for example, PHOTOMER 6010 from Henkel Corp., Hoboken, N.J.); EBECRYL (for example, EBECRYL 220 (a hexafunctional aromatic urethane acrylate of molecular weight 1000), EBECRYL 284 (aliphatic urethane diacrylate of 1200 grams/mole molecular weight diluted with 1,6-hexanediol diacrylate), EBECRYL 4827 (aromatic urethane diacrylate of 1600 grams/mole molecular weight), EBECRYL 4830 (aliphatic urethane diacrylate of 1200 grams/mole molecular weight diluted with tetraethylene glycol diacrylate), EBECRYL 6602 (trifunctional aromatic urethane acrylate of 1300 grams/mole molecular weight diluted with trimethylolpropane ethoxy triacrylate), and EBECRYL 840 (aliphatic urethane diacrylate of 1000 grams/mole molecular weight)) from Allnex (Germany); SARTOMER (for example, SARTOMER 9635, 9645, 9655, 963-B80, and 966-A80) from Sartomer Co., West Chester, Pa.; and UVITHANE (for example, UVITHANE 782) from Morton International, Chicago, Ill.

Commercially available aliphatic urethane (meth)acrylate crosslinkers include those available from Soltech Ltd., Kyoungnam, Korea, such as SU 500 (aliphatic urethane diacrylate with isobornyl acrylate), SU 5020 (hexa-functional aliphatic urethane acrylate oligomer with 26% butyl acetate), SU 5030 (hexa-functional aliphatic urethane acrylate oligomer with 31% butyl acetate), SU 5039 (nona(9)-functional aliphatic urethane acrylate oligomer), SU 511 (aliphatic urethane diacrylate), SU 512 (aliphatic urethane diacrylate), SU 514 (aliphatic urethane diacrylate with hexane diol diacrylate (HDDA)), SU 591 (aliphatic urethane triacrylate with N-(2-hydroxypropyl) methacrylamide), SU 520 (deca(10)-functional aliphatic urethane acrylate), SU 522 (hexa-functional aliphatic urethane acrylate), SU 5225 (aliphatic urethane diacrylate with isobornyl acrylate), SU 522B (hexa-functional aliphatic urethane acrylate), SU 5260 (aliphatic urethane triacrylate), SU 5270 (aliphatic urethane diacrylate), SU 530 (aliphatic urethane diacrylate), SU 5347 (aliphatic urethane diacrylate), SU 542 (low viscosity aliphatic urethane diacrylate), SU 543 (low viscosity aliphatic urethane diacrylate), SU 564 (aliphatic urethane triacrylate with HDDA), SU 565 (aliphatic urethane triacrylate with tripropylene glycol diacrylate), SU 570 (aliphatic urethane diacrylate), SU 571 (hexa functional aliphatic urethane diacrylate), SU 574 (aliphatic urethane triacrylate with HDDA), SU 574B (aliphatic urethane triacrylate with HDDA), SU 580 (aliphatic urethane diacrylate), SU 584 (aliphatic urethane triacrylate with HDDA), SU 588 (aliphatic urethane triacrylate with 2-(2-ethoxyethoxy) ethyl acrylate), and SU 594 (aliphatic urethane triacrylate with HDDA).

Commercially available aromatic urethane (meth)acrylate crosslinkers include those available from Soltech Ltd., Kyoungnam, Korea, such as SU 704 (aromatic urethane triacrylate with HDDA), SU 710 (aromatic urethane diacrylate), SU 720 (hexa-functional aromatic urethane acrylate), and SU 7206 (aromatic urethane triacrylate with trimethylolpropane triacrylate).

In some embodiments, the urethane (meth)acrylate crosslinker has a number average molecular weight of 900-20,000 Daltons (grams/mole) as measure using Gel Permeation Chromatography. If the number average molecular weight is less than 900 Daltons, the cured material tends to be brittle, leading to low T-peel strength. If the number average molecular weight is greater than 20,000 Daltons, however, the viscosity of the polymerizable composition may be too high. In some embodiments, the urethane multifunction (meth)acrylate has a number average molecular weight of 3,000-20,000 Daltons or 5,000 to 20,000 Daltons as measured using Gel Permeation Chromatography.

In some embodiments, the curable composition comprises 10-60 wt. %, 15-50 wt. %, or 20-40 wt. % of one or more urethane (meth)acrylate crosslinkers.

### Non-Urethane (Meth)Acrylate Crosslinker

Non-urethane (meth)acrylate crosslinkers useful in embodiments of the present disclosure include at least two (meth)acryl groups but do not include a urethane linkage. Suitable non-urethane (meth)acrylate crosslinkers for use in the curable compositions include oligomers and prepolymers comprising aliphatic multifunctional (meth)acrylates and aromatic multifunctional (meth)acrylates. In some embodiments, the non-urethane (meth)acrylate crosslinkers are selected from di(meth)acrylates, tri(meth)acrylates, tetra(meth)acrylates and combinations thereof. In some embodiments, the non-urethane (meth)acrylate crosslinker is a tri(meth)acrylate.

Exemplary agents include trimethylolpropane trimethacrylate (SR350 from Sartomer), trimethylolpropane triacrylate (SR351 from Sartomer), 1,6-hexanediol di(meth)acrylate (HDDA from UCB Radcure, Inc. of Smyrna, Ga.), tripropylene glycol di(meth)acrylate, polyethylene glycol di(meth)acrylate (Sartomer 344), tripropylene glycol di(meth)acrylate, neopentyl glycol dialkoxy di(meth)acrylate, polyethyleneglycol di(meth)acrylate, 1,3-butylene glycol diacrylate (e.g., commercially available as SR-212 from Sartomer), 1,6-hexanediol diacrylate (e.g., commercially available as SR-238 from Sartomer), neopentyl glycol diacrylate (e.g., commercially available as SR-247 from Sartomer), and diethylene glycol diacrylate (e.g., commercially available as SR-230 from Sartomer). Commercially available non-urethane (meth)acrylate crosslinkers include those available from Miwon Specialty Chemical Co. Ltd., Gwanggyo, Korea, such as, for example MIRAMER M301.

In some embodiments, the curable composition comprises 0.1 wt. % to 10 wt. %, 0.5 wt. % to 5 wt. %, or 1 wt. % to 3 wt. % of one or more non-urethane (meth)acrylate crosslinkers.

### Catalyst System

The Part A component further comprises a catalyst system including a quaternary ammonium halide and a transition metal (e.g., copper) source. The quaternary ammonium halide may accelerate the free-radical polymerization rate. Suitable quaternary ammonium halides include those having four hydrocarbyl (e.g., alkyl, alkenyl, cycloalkyl, aralkyl, alkaryl, and/or aryl) groups. Preferably, the hydrocarbyl groups are independently selected from hydrocarbyl groups having from 1 to 18 carbon atoms, more preferably 1 to 12 carbon atoms, and more preferably 1 to 4 carbon atoms. Examples of suitable hydrocarbyl groups include methyl, ethyl, propyl, butyl, hexyl, octyl, dodecyl, hexadecyl, and octadecyl, benzyl, phenyl, tolyl, cyclohexyl, and methylcyclohexyl. Exemplary suitable quaternary ammonium compounds include tetramethylammonium halides, tetraethylammonium halides, tetrapropylammonium halides, tetrabutylammonium halides, ethyltrimethylammonium halides, diethyldimethylammonium halides, trimethylbutylammonium halides, and benzyltributylammonium halides. Any halide (e.g., F, Cl, Br, I) ion may be used in the quaternary ammonium halide, but preferably the halide ion is chloride or bromide. In some embodiments, the transition metal source may be a transition metal salt of naphthenic acid, such as, for example, copper (II) naphthenate. In some embodiments, the quaternary ammonium halide may be a benzyltributyl ammonium halide such as, for example, benzyltributyl ammonium chloride.

In some embodiments, the curable composition comprises less than 0.1 wt. %, more particularly 0.03-0.1 wt. %, or 0.03-0.05 wt. % of the transition metal source. In some embodiments, the curable composition comprises less than 2 wt. %, more particularly 0.01-2 wt. %, or 0.3-0.5 wt. % of the quaternary ammonium halide.

### Photoinitiator System

The photoinitiator systems comprise a photoinitiator and optional photosensitizer. Suitable photoinitiators can be activated by electromagnetic radiation in the 340-550 nm range and have an extinction coefficient of from 10 to 2000 L/mol·cm (e.g., 50 to 500 L/mol·cm or 100 to 700 L/mol·cm) at a wavelength from 340-550 nm. Alternatively, photoinitiators can be used in combination with photosensitizers that absorb at wavelengths above 340 nm and excite the photoinitiator through energy transfer. In some embodiments, the composition upon curing has a depth of cure of at least 5 mm after electromagnetic radiation exposure in the range of 400 to 500 nm at an intensity of 2 W/cm² for 5 seconds.

Suitable photoinitiators include quinones, coumarins, phosphine oxides, phosphinates, mixtures thereof and the like. Commercially available photoinitiators include camphorquinone (CPQ), phosphine oxides such as LUCIRIN TPO, LUCIRIN TPO-L, LUCIRIN TPO-XL available from BASF or IRGACURE 819, IRGACURE 2100 available from Ciba, and phosphine oxides available from IGM Resins USA Inc. under the OMNIRAD trade designation such ethyl-2,4,6-trimethylbenzoylphenyl phosphinate (e.g., available as OMNIRAD TPO-L), 2,4,6-trimethylbenzoyl-diphenyl-phosphine oxide (e.g., available as OMNIRAD TPO), and bis-(2,4,6-trimethylbenzoyl)-phenylphosphine oxide (e.g., available as OMNIRAD 819). In some embodiments, the photoinitiator is

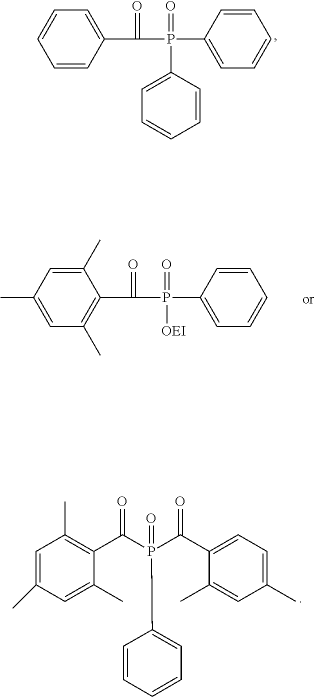

In some embodiments, the curable composition comprises less than 5 wt.%, more particularly 0.1-5 wt.% of one or more photoinitiators.

Examples of suitable photosensitizers include, for example, camphorquinone, coumarin photosensitizers such as (7-ethoxy-4-methylcoumarin-3-yl)phenyliodonium hexafluoroantimonate, (7-ethoxy-4-methylcoumarin-6-yl)]phenyliodonium hexafluoroantimonate, (7-ethoxy-4-methylcoumarin-3-yl) phenyliodonium hexafluorophosphate, (7-ethoxy-4-methylcoumarin-6-yl]phenyliodonium hexafluorophosphate, such as those described in Ortyl and Popielarz, Polimery 57: 510-517 (2012); 1,3-dioxane methyl coumarin, such as is described in Yin et al., Journal of Applied Polymer Science 125: 2371-2371 (2012); coumarin dye; and ketocoumarin dye. Other examples of suitable photosensitizers and accelerators are described, for example, in U.S. Pub. No 2019/0000721 (Ludsteck et al.) and U.S. Pat. No. 8,501,834 (Maletz et al.), the contents of which are incorporated herein in their entireties. In some embodiments, the curable composition comprises 0.0001 wt. % to 5 wt. % of one or more photosensitizers.

### Additional Components

In some embodiments, Part A may further comprise at least one of a filler, a plasticizer, and a rheology modifier. In some embodiments, Part A may further comprise one or more curative aids.

### Fillers

The inorganic filler, when present, is chosen to minimize interference with the light curing process. The filler particles or fibers are of sufficient size that a mismatch in the refractive index between the filler and curing resin could reduce the penetration of light into the curable composition and render the depth of cure insufficient for the intended application. Therefore, to minimize the effects of light scatter by the filler and to insure sufficient depth of curing, the sum of the absolute value of the difference in the refractive index of the filler and the refractive index of the composition cured without filler plus the birefringence of the filler is 0.054 or less, i.e.

0.054≥|n_{filler}−nₘₐₜᵣᵢₓ|+δ_{filler}, where
n_{filler} is the refractive index of the filler,
nₘₐₜᵣᵢₓ is the refractive index of the composition cured without filler, and
δ_{filler} is the birefringence of the filler.

The inorganic fillers can improve impact resistance and increase hardness. Additionally, the inorganic fillers can reduce the amount of diluent used in the curable composition. Many suitable diluents are volatile organic compounds (VOCs) that can not only have a negative impact on the environment but can also generate unwanted odors as the diluent is vaporized by the heat generated during the curing process. The inorganic fillers can reduce the amount of diluent when contrasted with the curable composition without the filler. Additionally, the filler can act as a heat sink to reduce the temperature of the curing composition, which in turn reduces or eliminates volatilization of the diluent.

It is preferable to use inorganic fillers that reduce or minimize the effects of light scattering in order to insure sufficient depth of curing. Therefore, inorganic fillers of the present disclosure are selected such that the sum of the absolute value of the difference in the refractive index of the filler and the refractive index of the composition cured without filler plus the birefringence of the filler is 0.054 or less.

In some embodiments, the inorganic filler has a higher refractive index than the organic phase of the curable composition (i.e. everything but the inorganic filler). In some embodiments, the refractive index of the inorganic filler is between the refractive indices of the organic phases of the uncured and cured compositions. More particularly, in some embodiments, the refractive index of the inorganic filler is midway between the refractive indices of the organic phases of the uncured and the cured compositions.

In some embodiments, the inorganic filler may have a refractive index of at least 1.490, 1.500, 1.510, 1.520, 1.530, or 1.540, the organic phase of the curable composition may have a refractive index of 1.460, 1.470, 1.480, 1.490, 1.500, 1.510, and the cured organic phase of the composition may have a refractive index of 1.480, 1.490, 1.500, 1.510, 1.520, 1.530. In some preferred embodiments, the cured organic phase of the composition may have a refractive index of 1.500 to 1.530. As curing proceeds, the curable composition typically becomes more and more translucent, enabling higher depth of cure.

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

Suitable inorganic fillers have at least one dimension greater than 200nm. For example, in the case of spherical fillers, the diameter of the particles is at least 200 nm. In the case of fibers, the length (longest dimension) of a fiber is at least 200 nm.

Exemplary inorganic fillers include inorganic metal oxides, inorganic metal hydroxides, inorganic metal carbides, inorganic metal nitrides such as ceramics, and various glass compositions (e.g., borate glasses, phosphate glasses, and fluoroaluminosilicate). More particularly, inorganic fillers include alumina trihydrate, alumina, silica, silicate, beryllia, zirconia, magnesium oxide, calcium oxide, zinc oxide, titanium dioxide, aluminum titanate, silicon carbide, silicon nitride, aluminum nitride, titanium nitride, aluminum trihydrate, and magnesium hydroxide.

Commercially available inorganic fillers include 3M CERAMIC MICROSPHERE WHITE GRADES W-210, W-410 and W-610 from 3M Company (St. Paul, Minn.), MINEX brand micronized functional fillers such as MINEX 3 Nepheline Syenite, MINEX 7 Nepheline Syenite and MINEX 10 Nepheline Syenite from Carry Company (Addison, Ill.), Schott dental glass type GM27884 from Schott (Southbridge, Mass.), DRAGONITE-XR halloysite clay from Applied Minerals (New York, N.Y.). In preferred embodiments, the filler is uniformly distributed throughout the curable composition and does not separate from the polymerizable composition before or during curing.

In some embodiments, the curable composition comprises up to 40 wt. % (e.g., 5 of one or more inorganic fillers. Compositions comprising less than 5 wt. % of inorganic filler typically require a higher amount of diluent (e.g., volatile organic compounds) and reduce the potential heat sink effect mentioned above. Compositions comprising greater than 50 wt. % inorganic filler can diminish cure depth.

### Plasticizer

Useful plasticizing agents are compatible with the disclosed curable compositions, such that once the plasticizing agent is mixed with other components of the compositions the plasticizing agent does not phase separate. By “phase separation” or “phase separate”, it is meant that by differential scanning calorimetry (DSC) no detectable thermal transition, such as a melting or glass transition temperature, can be found for the pure plasticizing agent in curable composition. Some migration of the plasticizing agent from or throughout the curable composition can be tolerated, such as minor separation due to composition equilibrium or temperature influences, but the plasticizing agent does not migrate to the extent of phase separation between the curable composition and the plasticizing agent. Plasticizing agent compatibility with the curable composition can also be determined by the chemical nature of the plasticizing agent and the comonomers. For example, polymeric plasticizing agents based on polyether backbones (such as polyethylene glycols) are observed to be more compatible than polyester plasticizing agents, especially when higher levels of acidic comonomer such as acrylic acid are used.

For these same reasons, the plasticizing agent is also non-volatile. The plasticizing agent must remain present and stable under polymerization reaction conditions to serve as a polymerization medium for the marginally compatible comonomers. To maintain adhesion properties, the plasticizing agent must again remain present and not significantly evaporate from the polymerized curable adhesive composition.

Additionally, the plasticizing agent is non-reactive to prevent reaction or interference with the polymerization of the curable composition. Thus, plasticizing agents having acrylate functionality, methacrylate functionality, styrene functionality, or other ethylenically unsaturated free radically reactive functional groups are not used. Non-reactive plasticizing agents also reduce the inhibition or retardation of the polymerization reaction and/or the alteration of the final polymer structure that can occur if the plasticizing agent acts as a chain-transfer or chain-terminating agent. Such undesirable effects can adversely influence the performance and stability of the materials polymerized in the presence of these plasticizing agents. Chain termination can also result in undesirably high residual volatile materials (i.e., lower conversion of the comonomers).

Particularly useful plasticizing agents include polyalkylene oxides having weight average molecular weights of about 200 to about 500 grams per mole, preferably of about 250 to about 400 grams per mole, such as polyethylene oxides, polypropylene oxides, polyethylene glycols; alkyl or aryl functionalized polyalkylene oxides, such as PYCAL 94 (a phenyl ether of polyethylene oxide, commercially available from ICI Chemicals); benzoate esters, such as Benzoflex 9-88 commercially available from Eastman Chemical Eastman Chemical, Kingsport, Tenn., and monomethyl ethers of polyethylene oxides, and mixtures thereof.

The plasticizing agent can be used in amounts of from about 10 wt. % to 45 wt. %, preferably of about 15 wt. % to 25 wt. %. The amount of plasticizer required depends upon the type and ratios of the other components employed in the polymerizable mixture and the chemical class and molecular weight of the plasticizing agent used in the composition.

### Rheology Modifiers

Reinforcing silica can be used as a viscosity and thixotropy modifier. In some embodiments, the viscosity of the curable composition is 5-1,000 PaS. For example, the silica may be added in amounts to achieve a viscosity such that the composition is self-wetting, i.e. freely flowing on the surface of the substrate and filling voids. The silica may be added in amounts such that the composition is sprayable. Finally, the silica may be added in amounts such that the composition forms a caulk for filling spaces, voids or interstices of substrates.

Suitable reinforcing silicas typically have a primary particle dimension no greater than 100 nm and, therefore, have little to no effect on the penetration of light within the composition during curing. As used herein, the term “primary particle” means a particle in unaggregated form, although the primary particle may be combined with other primary particles to form aggregates on the micron size scale. Reinforcing silicas include fused or fumed silicas and may be untreated or treated so as to alter the chemical nature of their surface. Examples of treated fumed silicas include polydimethylsiloxane-treated silicas, hexamethyldisilazane-treated silicas and silicas that are surface treated with alkyltrimethoxysilanes, such as hexyl (C6), octyl (C8), decyl (C10), hexadecyl (C16), and octadecyl(C18)trimethoxysilanes. Commercially available treated silicas are available from Cabot Corporation under the tradename CAB-O-SIL ND-TS, such as CAB-O-SIL TS 720, 710, 610, 530, and Degussa Corporation under the tradename AEROSIL, such as AEROSIL R805.

Of the untreated silicas, amorphous and hydrous silicas may be used. Commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm. Commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.).

In some embodiments, the curable composition comprises 1-10 wt. % of one or more reinforcing silicas.

### Curative Aids

It may be desirable in some circumstances to reduce tackiness and/or mitigate oxygen inhibition at the surface of the curable composition. To address at least these issues, in some embodiments, the Part A component may further include one or more curative aides such as, for example, secondary or tertiary (meth)acrylate amines, such as, for example, 2-(dimethylamino)ethyl methacrylate or t-butylaminoethyl) methacrylate; acrylated oligo-amine resin (e.g., Genomer 5695); acrylamides such as N,N-dimethylacrylamide; secondary or tertiary amines such as, for example, methyldiethanolamine, N,N-dimethylaminobenzoate, 2-(N-methyl-N-phenylamino)-1-phenylethanol, or alkyldimethylamine; small molecule organosilanes such as, for example, tris(trimethylsilyl)silane, 1,3,5,7 tetramethylcyclotetrasiloxane, or 3-(dimethylsilyloxy)-1,1,5,5-tetramethyl-3-phenyltrisiloxane; phosphines and phosphites such as, for example, triphenylphosphine, triphenylphosphite, or trialkylphosphite; a (meth)acrylate phosphate ester (e.g., Harcyl 1228); waxes and hydrophobic non-reactive resins such as, for example, paraffin wax, hydrophobic acrylate esters (e.g., CN307), members of the BYK-S product line available from BYK USA Co., Wallingford, Conn., such as, for example, BYK-S 782; isoprenyl methacrylate (“IPEMA” available from Kuraray, Tokyo, Japan); or 1,3-bis(prenyloxy)-2-propanol (“DPNG” available from Kuraray, Tokyo, Japan).

In some embodiments, the Part A component comprises up to 10 wt. % (e.g., 0.1 wt % to 8 wt. %) of one or more curative aids.

### Part B Component

The Part B component comprises barbituric acid or a derivative thereof and/or a malonyl sulfamide and optionally an organic peroxide curative. Curing systems useful in embodiments of the present disclosure include redox initiator systems having a barbituric acid derivative and/or a malonyl sulfamide and optionally an organic peroxide, selected from the group of the mono- or multifunctional carboxylic acid peroxide esters. Barbituric acid derivatives useful in embodiments of the present disclosure include, for example, 1,3,5-trimethylbarbituric acid, 1,3,5-triethylbarbituric acid, 1,3-dimethyl-5-ethylbarbituric acid, 1,5-dimethylbarbituric acid, 1-methyl-5-ethylbarbituric acid, 1-methyl-5-propylbarbituric acid, 5-ethylbarbituric acid, 5-propylbarbituric acid, 5-butylbarbituric acid, 1-benzyl-5-phenylbarbituric acid, 1-cyclohexyl-5-ethylbarbituric acid and the thiobarbituric acids mentioned in the German patent application DE-A-42 19 700. The barbituric acids and barbituric acid derivatives described in German patent specification DE-C-14 95 520 as well as the malonyl sulfamides named in the European patent specification EP-B-0 059 45 lare also well suited. Preferred malonyl sulfamides are 2,6-dimethyl-4-isobutylmalonyl sulfamide, 2,6-diisobutyl-4-propylmalonyl sulfamide, 2,6-dibutyl-4-propylmalonyl sulfamide, 2,6-dimethyl-4-ethylmalonyl sulfamide or 2,6-dioctyl-4-isobutylmalonyl sulfamide.

In preferred embodiments, the Part B component comprises up to 50 wt. % (e.g., 10 wt. % to 50 wt. %, 15 wt. % to 25 wt. %) of barbituric acid or a derivative thereof and/or a malonyl sulfamide.

In some embodiments, Part B also includes at least one organic peroxide curative. Typically, the amount of organic peroxide curative is up to 5 percent by weight, e.g., 0.1 to 5 percent by weight or 1.5 to 2.5 percent by weight, although other amounts may also be used. Exemplary organic peroxide curatives include 1,1-di-(tert-amylperoxy)cyclohexane, 1,1-di-(tert-butylperoxy)-3,3,5-trimethylcyclohexane, 1, 1-di-(tert-butylperoxy)cyclohexane, 2,2-di-(tert-butylperoxy)butane, 2,2-dihydroperoxypropane, 2,4-dichlorobenzoyl peroxide, 2,5-bis-(2-ethylhexanoylperoxy)-2,5-dimethylhexane, 2,5-dimethyl-2,5-di(benzoylperoxy)hexane, 2,5-dimethyl-2,5-di-(tert-butylperoxy)hex-3-yne, 2,5-dimethyl-2,5-dihydroperoxyhexane, 3,3,6,6,9,9-hexamethyl-1,2,4,5-tetraoxacyclononane, 3,3-di-(tert-butylperoxy) butyrate, 3-chloroperoxybenzoic acid, acetyl benzoyl peroxide, benzoyl peroxide (BPO), bis(2-phenethyl)benzoyl peroxide, bis-(4-tert-butylcyclohexyl) peroxide carbonate, bis(p-octyl)benzoyl peroxide, cumyl hydroperoxide, cyclohexanone peroxide, di-(2-phenoxyethyl) peroxydicarbonate, dicumyl peroxide, disuccinic acid peroxide, di-(tert-butyl) peroxide, methyl ethyl ketone peroxide, methyl isobutyl ketone peroxide, n-butyl-4,4-di-(tert-butylperoxy)valerate, tert-amyl peroxybenzoate, tert-butyl hydroperoxide, tert-butyl monoperoxymaleate, tert-butyl peroxy-2-ethylhexanoate, tert-butyl peroxy-3,5,5-trimethylhexanoate, tert-butyl peroxy-2-ethylhexylcarbonate, tert-butyl peroxyacetate, tert-butyl peroxybenzoate, tert-butyl peroxyisopropyl, carbonate, tert-butyl monoperoxymaleate, tert-butyl peroxy-2-methylbenzoate, and combinations thereof. In some embodiments, the organic peroxide comprises a carboxylic acid peroxy ester. An exemplary organic peroxide useful in embodiments of the present disclosure is commercially available from Akzo Nobel, Amsterdam, Netherlands under the trade designation “TRIGONOX 42S.”

### Additional Components

In some embodiments, Part B may further comprise at least one of a filler, a plasticizer, and a rheology modifier in amounts as described above for Part A.

In some embodiments, Part B may further comprise up to 10 wt. % (e.g., 0.1 wt. % to 8 wt. %) of one or more curative aids such as, for example, primary, secondary, or tertiary (meth)acrylate amines, such as, for example, methyldiethanolamine, N,N-dimethylaminobenzoate, 2-(N-methyl-N-phenylamino)-1-phenylethanol, and alkyldimethylamine; small molecule thiols such as, for example, alkylthiols, pentaerythritol tetrakis-3-mercaptopropionate, and trimethylolpropane tris(3-mercaptopropionate);

mercaptobenzoxazole, mercaptobenzothiazole; polymer-modified thiols such as, for example, a polymer captopropylmethylsiloxane, and a mercaptan-modified polyether acrylate (e.g., GENOMER 7302); small molecule organosilanes such as, for example, tris(trimethylsilyl)silane, 1,3,5,7 tetramethylcyclotetrasiloxane and 3-(dimethylsilyoxy)-1,1,5,5-tetramethyl-3-phenyltrisiloxane; and waxes and hydrophobic non-reactive resins such as paraffin wax, hydrophobic acrylate esters (e.g., CN307), and members of the BYK-S product line available from BYK USA Co., Wallingford, Conn., such as, for example, BYK-S 782.

Curable compositions according to the present disclosure are useful, for example, for sealing a substrate and/or adhering two substrates. To seal a substrate, including gap filling between bonded components in an electronic device, a curable composition (mixed Parts A and B) according to the present disclosure may be applied to a surface of the substrate. Any suitable method of application may be used including, for example, dispensing from a nozzle (e.g., a mixing nozzle). Typically the curable composition will include Part A: Part B in a ratio of 10:1 to 4:1. Once applied, the curable composition is at least partially cured by exposure to a light source such as, for example, a 3M Blue Light Gun (450 nm LED source, 3M Company, Saint Paul, Minn.) for example, for at least 5 seconds, at least 10 seconds, or at least 15 seconds with the source at a distance of, for example, about 1 cm, 2 cm, or 3 cm from the sample. While time is generally sufficient to cause curing at room temperature, optional heating may be applied to accelerate curing.

Exemplary substrates may include, metal (e.g., steel), polymer, glass, ceramic, and combinations thereof. Particular examples include electronic component assemblies, automotive articles, and aviation/aerospace components.

The curable composition may also be used to adhere two substrates. To adhere two substrates, a curable composition (mixed Parts A and B) according to the present disclosure may be applied to a surface of a first substrate. Typically the curable composition will include Part A: Part B in a ratio of 10:1 to 4:1. Any suitable method of application may be used including, for example, dispensing from a nozzle (e.g., a mixing nozzle). Next, a second surface of a second substrate is contacted with the curable composition, and the curable composition is at least partially cured by exposure to a light source such as, for example, a 3M Blue Light Gun (450 nm LED source, 3M Company, Saint Paul, Minn.) for at least 5 seconds, at least 10 seconds, or at least 15 seconds with the source at a distance of about 1 cm, 2 cm, or 3 cm from the sample. While time is generally sufficient to cause curing at room temperature, optional heating may be applied to accelerate curing.

Curable compositions of the present disclosure desirably have open times of at least 10, 20, 30, 40, 50, 60, 70, or 75 minutes, and preferably less than 120, 110, 100, or 90 minutes.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted or readily apparent from the context, all parts, percentages, ratios, etc. in the Examples and the rest of the specification are by weight. All chemicals were purchased from the given suppliers and used as received.

TABLE 1
Materials

| Name | Source |
|---|---|
| OMNIRAD 819 | IGM, Charlotte, NC |
| CAB-O-SIL TS-720 | Cabot Corp., Boston, MA |
| MINEX 3 | Sibelco, Antwerp, Germany |
| Benzotriazole | PMC Specialties, Cincinnati, OH |
| MIRAMER M142 (M142) | Miwon Specialty Chemical Co., Exton, PA |
| MIRAMER M301 (M301) | Miwon Specialty Chemical Co., Exton, PA |
| PROSTAB 5198 | BASF, Ludwigshafen, Germany |
| HEMA succinate (Light ester HO-MS) | Kyoeisha Chemical Co., Osaka, Japan |
| BENZOFLEX 9-88 | Eastman Chemical, Kingsport, TN |
| 1-Benzyl-5-phenyl barbituric acid (“BA”) | PCM Products GmbH, Krefeld, Germany |
| TRIGONOX 42S (“Peroxide”) | Akzo Nobel, Amsterdam, Netherlands |
| Cu(II) naphthenate (8% in mineral oil) | Strem Chemicals, Newburyport, MA |
| Benzyltributyl ammonium chloride (“BAC”) | SACHEM, Austin, TX |
| Trimethylolpropane tris(3-mercaptopropionate) | TCI Co., Ltd., Tokyo, Japan |
| (“TMPMP”) | |
| Tris(trimethylsilyl)silane | Alfa Aesar, Haverhill, MA |
| GENOMER 5695 (“G5695”) | Rahn USA Corp., Aurora, IL |
| BYK-S 782 | BYK USA Co., Wallingford, CT |
| Isoprenyl methacrylate (“IPEMA”) | Kuraray, Tokyo, Japan |
| 1,3-bis(prenyloxy)-2-propanol (“DPNG”) | Kuraray, Tokyo, Japan |
| Triphenyl phosphite | Alfa Aesar, Haverhill, MA |
| Steel t-peel substrates (4 × 0.3 inch) | Cold-rolled steel panels, CRS 1018 20-gauge, |
| | 3M Fabrication Services, St. Paul, MN |
| Isopropanol | EMD Milipore, Burlington, MA |
| 2K Epoxy resin | EMD Milipore, Burlington, MA |

### Test Methods

### T-Peel Adhesion Test

Freshly abraded 3×0.3-inch steel t-peel substrates were rinsed with isopropanol and allowed to air dry. A seam sealer mixture was applied to the abraded surface of one substrate at a thickness of 3 mm, and then covered with a second substrate to form the t-peel sample. After removing excess seam sealer from the edges, the sample was cured using a 3M Blue Light Gun (450 nm LED source, 3M Company, Saint Paul, Minn.) for 30 seconds on each long edge, and 5 seconds on the short edges. The T-peel adhesion tests were done on an Instron 3342 tester (Instron, Norwood, Mass.) at 2.0 inch/min speed to obtain average peel strength and peak load. Samples were repeated in triplicate.

### Corrosion Resistance Test

Accelerated corrosion tests were performed following the ASTM B117 procedure. Freshly abraded cold-rolled steel panels were rinsed with isopropanol and air-dried. A seam sealer was then applied at a thickness of 50 mils to an area of approximately 3.5×3.5 inches and cured from the top using a 3M Blue Light Gun (450 nm LED source, 3M Company, Saint Paul, Minn.) for 1 minute. The edges of the applied seam sealer and the panel were then sealed with a 2K epoxy resin. The panels were placed in a salt fog chamber (5 wt % NaCl and air-sparging) for three weeks. Samples were repeated in triplicate. Once the test was completed, the panels were removed, rinsed and dried, and evaluated for corrosion by direct inspection.

### Open-Time Measurement

After thorough mixing, a seam sealer formulation is dispensed onto a smooth surface (e.g., 3M Disposable Paper Mixing surface) in approximately 0.5×0.5×2-inch beads under ambient lab lighting (fluorescent lighting). At a given time point, a bead is probed with a wooden applicator. The earliest time point where cured or skinned-over material appeared is recorded as the open time.

### Dark-Cure Time Measurement

After thorough mixing, the seam sealer was dispensed onto a given surface (preferably an e-coat panel) and an approximately 0.5×0.5×5-inch bead was drawn out with a plastic spatula. The sample was then placed either in a dark hood with filtered ambient light or tented with aluminum foil. At a given time point, and at approximately half inch intervals along the length of the bead, the sample was cut through with a razor blade to determine the cross-section's depth of cure. The earliest time point where the bead had cured through completely was recorded as the dark cure time.

### General Procedure for Preparing Seam Sealer Formulations

BENZOFLEX 9-88 and 1-benzyl-5-phenyl barbituric acid were combined in a glass jar and rolled at room temperature overnight. An acrylic stock solution was prepared by combining MIRAMER M142, OMNIRAD 819, benzotriazole, and PROSTAB 5198 in an amber glass jar and rolled under a heat lamp until all the solids dissolved. Once cool, the appropriate amount of acrylic stock solution was weighed into a speed mixer jar, followed by HEMA succinate, MIRAMER M301, GENOMER 4230, Cab-O-SIL TS-720, and MINEX 3. The mixture was homogenized using a FlackTek DAC 400.2 Vac speed mixer: 3 cycles of 1 minute at 2000 rpm without vacuum. Cu(II) and BAC (40 wt % in HEMA succinate) were weighed in, and mixed for 1 cycle of 1 minute at 2000 rpm. The BENZOFLEX/barb acid slurry was then weighed in and mixed for 1 cycle of 1 minute at 1000 rpm, then 1 minute at 1500 rpm and 50 mbar. Last, the redox initiator (10 wt % in BENZOFLEX 9-88) was then weighed in and mixed for 15 seconds at 2000 rpm.

Table 2 shows an example formulation for an approximately 200 gram sample. The relative ratios of all these components were held constant throughout the examples. The relative amounts of peroxide, barbituric acid, ammonium chloride and copper were varied (Tables 3 and 4). The OMNIRAD 819 concentration was held constant at 2.5 wt % for examples 1 to 10 and at 1.3 wt. % for examples 11 to 19 (wt. % relative to the total weight of the COD components). The weight percent values reported in Tables 3-6 were calculated based on the total mass of the reagents listed in Table 2. Open time and dark cure time were measured for the examples in Tables 3 and 4.

TABLE 2
Cure-on-Demand (“COD”) Components

| | | Relative |
|---|---|---|
| Reagent | Amount/g | wt. % |
| MIRAMER M142 | 20 | 10.5 |
| HEMA succinate | 30 | 15.8 |
| GENOMER 4230 | 50 | 26.3 |
| M301 | 4 | 2.1 |
| Benzotriazole | 2 | 1.0 |
| PROSTAB 5198 | 0.1 | 0.05 |
| CAB-O-SIL TS-720 | 7 | 3.7 |
| MINEX 3 | 77 | 40.5 |

TABLE 3
Open Time and Dark Cure Time with 2.5 wt. % Photoinitiator

| | | | | | | Dark |
|---|---|---|---|---|---|---|
| | | | | | Open | Cure |
| | Peroxide | BA | BAC | Cu(II) | Time | Time |
| Example | (wt. %) | (wt. %) | (wt. %) | (wt. %) | (minutes) | (hours) |
| 1 | 0 | 10 | 0.4 | 0.1 | 30 | 12-24 |
| 2 | 5 | 10 | 0.4 | 0.1 | 0 | N/A |
| 3 | 0.04 | 10 | 0.4 | 0.1 | <30 | 1.5 |
| 4 | 0.48 | 4.73 | 1.0 | 0.1 | 10 | 0.67 |
| 5 | 0.31 | 2.87 | 0.60 | 0.06 | 10 | 0.67 |
| 6 | 0.24 | 2.44 | 0.5 | 0.05 | 20 | 2 |
| 7 | 0.15 | 1.50 | 0.3 | 0.03 | 50 | 16 |
| 8 | 0.19 | 1.99 | 0.4 | 0.04 | 30 | 3 |
| 9 | 0.15 | 2.41 | 0.5 | 0.05 | 20 | 3.5 |
| 10 | 0.15 | 0.98 | 0.5 | 0.05 | 60 | 16 |

TABLE 4
Open Time and Dark Cure Time with 1.3 wt.% Photoinitiator

| | | | | | | Dark |
|---|---|---|---|---|---|---|
| | | | | | Open | Cure |
| | Peroxide | BA | BAC | Cu(II) | Time | Time |
| Example | (wt. %) | (wt. %) | (wt. %) | (wt.%) | (minutes) | (hours) |
| 11 | 0.19 | 1.99 | 0.41 | 0.04 | 40 | 2.5 |
| 12 | 0.19 | 1.5 | 0.41 | 0.04 | 45 | 3 |
| 13 | 0.19 | 1.0 | 0.41 | 0.04 | 75 | no cure |
| 14 | 0.19 | 1.5 | 0.41 | 0.04 | 40 | 5-6 |
| 15 | 0.19 | 1.5 | 0.82 | 0.04 | 40 | 5-6 |
| 16 | 0.19 | 1.5 | 0.2 | 0.04 | 55 | no cure |
| 17 | 0.19 | 1.5 | 1.64 | 0.04 | 55 | no cure |
| 18 | 0.3 | 3 | 0 | 0 | 30 | N.D. |
| 19 | 0.4 | 3 | 0 | 0 | 30 | N.D. |

Table 5 shows the light-curing properties of selected examples from Tables 3 and 4 where the sample was irradiated with a 3M Blue Light Gun (450 nm LED source, 3M Company, Saint Paul, Minn.) for 10 seconds with the source at a distance of about 1 inch from the sample. Light-activated (“LA”) dark cure time refers to the cure time of the interior of a sample that was briefly exposed to light to form a cured skin.

TABLE 5
Light-Curing Properties of Examples

| | | | | | | LA Dark |
|---|---|---|---|---|---|---|
| | | | | | Cure | Cure |
| | Peroxide | BA | BAC | Cu(II) | Depth | Time |
| Example | (wt. %) | (wt. %) | (wt. %) | (wt.%) | (mm) | (hours) |
| 8 | 0.19 | 1.99 | 0.41 | 0.04 | 6 | N/A |
| 11 | 0.19 | 1.99 | 0.41 | 0.04 | 6 | N/A |
| 12 | 0.19 | 1.5 | 0.41 | 0.04 | 3 | 1 |
| 13 | 0.19 | 1.0 | 0.41 | 0.04 | 3 | 1 |
| 14 | 0.19 | 1.5 | 0.41 | 0.04 | 3 | no cure |
| 15 | 0.19 | 1.5 | 0.82 | 0.04 | 2-3 | 2 |
| 16 | 0.19 | 1.5 | 0.2 | 0.04 | 3-4 | 2 |
| 17 | 0.19 | 1.5 | 1.64 | 0.04 | 4-5 | 3/partial |
| 18 | 0.3 | 3 | 0 | 0 | 2-3 | 3/partial |
| 19 | 0.4 | 3 | 0 | 0 | 4.7 | N.D. |

The adhesion of the formulations to a bare metal substrate as well as the corrosion protection performance was quantified in Table 6. The adhesion performance was quantified by the peel force against steel. The corrosion performance was quantified for example 16. Examples 1 and 2 were formulated on a 3-gallon scale. Example 14 had rust covering well over 40% of the sample window at the end of the test.

TABLE 6
Adhesion and Corrosion Protection Performance

| | | | Corrosion |
|---|---|---|---|
| | | | performance (% rust |
| Formula | Maximum force (N) | Peel force (N/mm) | coverage of sample) |
| 1 | 24.37 ± 0.94 | 3.20 ± 0.12 | N.D. |
| 2 | 29.93 ± 2.34 | 3.93 ± 0.31 | N.D |
| 16 | 25.78 ± 3.38 | 3.38 ± 0.44 | >40% |

It was observed that fully dark-cured samples had a “slimy” or under-cured surface at the air interface, possibly due to oxygen inhibition. This result was not observed on light-cured surfaces. To aid in fully curing oxygen-exposed surfaces, a variety of additives at different loadings were tested (Table 7). Tris(trimethylsilyl)silane was found to work the best in this system. The sample surface was tacky to the touch, but the additive eliminated the top layer of free material.

TABLE 7
Surface-Cure Additives

| | | | Open time | Surface Cure |
|---|---|---|---|---|
| Example | Additive | Wt. % | (minutes) | Rating (1-5) |
| 20 | TMPMP | 0.5 | 35 | 1 |
| 21 | tris(trimethylsilyl)silane | 0.5 | 20 | 3 |
| 22 | GENOMER 5695 | 0.5 | 50 | 1 |
| 23 | TMPMP | 1.5 | 40 | 1 |
| 24 | BYK-S 782 | 1.5 | 35 | 1 |
| 25 | BYK-S 782 | 1 | 40 | 1 |
| 26 | IPEMA | 1 | N.D. | 1 |
| 27 | DPNG | 0.1 | N.D | 1 |
| 28 | TPP | 0.1 | 35 | 1 |

All cited references, patents, and patent applications in the above application for letters patent are herein incorporated by reference in their entirety in a consistent manner In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A two-part curable composition comprising:
a Part A component comprising:
a polymerizable monomer having one (meth)acryl group;
an adhesion promoter;
a urethane (meth)acrylate crosslinker having at least two (meth)acryl groups;
a non-urethane (meth)acrylate crosslinker having at least two (meth)acryl groups;
a catalyst system; and
a photoinitiator system; and
a Part B component comprising:
barbituric acid or a derivative thereof; and
optionally an organic peroxide curative.

2. The two-part curable composition of claim 1, wherein the polymerizable monomer having one (meth)acryl group does not contain an acidic group, an amino group, an anhydride group, or a hydroxyl group.

3. The two-part curable composition of claim 1, wherein the adhesion promoter comprises an acid-functionalized (meth)acrylate monomer.

4. The two-part curable composition of claim 1, wherein the urethane (meth)acrylate crosslinker having at least two (meth)acryl groups comprises an aliphatic urethane acrylate.

5. The two-part curable composition of claim 1, wherein the non-urethane (meth)acrylate crosslinker having at least two (meth)acryl groups is selected from di(meth)acrylates, tri(meth)acrylates, tetra(meth)acrylates, and combinations thereof.

6. The two-part curable composition of claim 1, wherein the catalyst system comprises a copper naphthenate.

7. The two-part curable composition of claim 1, wherein the catalyst system comprises a tributyl ammonium chloride.

8. The two-part curable composition of claim 1, wherein the photoinitiator comprises bis-(2,4,6-trimethylbenzoyl)-phenylphosphine oxide.

9. The two-part curable composition of claim 1, wherein the composition comprises 10 wt. % to 50 wt. % 1-benzyl-5-phenyl barbituric acid in Part B.

10. The two-part curable composition of claim 1, wherein the composition comprises up to 5 wt. % of the organic peroxide curative in Part B.

11. The two-part curable composition of claim 10, wherein the organic peroxide curative comprises a carboxylic acid peroxy ester.

12. The two-part curable composition of claim 1, wherein Part A further comprises at least one of a filler, a plasticizer, and a rheology modifier.

13. The two-part curable composition of claim 1, wherein Part B further comprises at least one of a filler, a plasticizer, and a rheology modifier.

14. The two-part curable composition of claim 12, wherein at least one of the fillers has a refractive index of 1.5 to 1.53.

15. The two-part curable composition of claim 1, wherein the composition upon curing has a depth of cure of at least 5 mm after electromagnetic radiation exposure in the range of 400 to 500 nm at an intensity of 2 W/cm² for 5 seconds.

16. A method comprising:
applying the two-part curable composition of claim 1 to a substrate; and
exposing the two-part curable composition to electromagnetic radiation in the range of 340-550 nm at an intensity of 0.1-5 W/cm².

17-20. (canceled)

21. An article comprising a first substrate having disposed thereon a reaction product of first components comprising:
a Part A component comprising:
a polymerizable monomer having one (meth)acryl group;
an adhesion promoter;
a urethane (meth)acrylate crosslinker having at least two (meth)acryl groups;
a non-urethane (meth)acrylate crosslinker having at least two (meth)acryl groups;
a catalyst system; and
a photoinitiator; and
a Part B component comprising:
1-benzyl-5-phenyl barbituric acid; and
optionally an organic peroxide curative.

22. The article of claim 21, further comprising a second substrate, wherein the reaction product of first components is sandwiched between the first and second substrates.

23. The article of claim 21, wherein the article is an automotive article.

24. The article of claim 21, wherein the first substrate comprises steel.
